(19) United States
(12) Patent Application Publication
(10) Pub. No.: US 2020/0149896 A1
(43) Pub. Date: May 14, 2020

(54) SYSTEM TO DERIVE AN AUTONOMOUS VEHICLE ENABLING DRIVABLE MAP

(71) Applicant: GM GLOBAL TECHNOLOGY OPERATIONS LLC, Detroit, MI (US)

(72) Inventors: Lawrence A. Bush, Shelby Township, MI (US); Michael A. Losh, Rochester Hills, MI (US); Brent N. Bacchus, Sterling Heights, MI (US); Aravindhan Mani, Troy, MI (US)

(73) Assignee: GM GLOBAL TECHNOLOGY OPERATIONS LLC, Detroit, MI (US)

(21) Appl. No.: 16/186,021

(22) Filed: Nov. 9, 2018

(51) Int. Cl. G01C 21/32; G06K 9/00; G06F 16/29; G05D 1/00; G05D 1/02

(52) U.S. Cl. CPC G01C 21/32; G06K 9/00798; G06K 9/00818; G06K 9/00825; G05D 2201/0213; G05D 1/0088; G05D 1/0246; G05D 1/0274; G06F 16/29

(57) ABSTRACT

A method for autonomous vehicle map construction includes automatically capturing location data, movement data, and perception data from a vehicle that has traveled down a road, wherein the perception data includes data that identifies the location of lane edges and lane markers for the road, the location of traffic signs associated with the road, and the location of traffic signaling devices for the road. The method further includes pre-processing to associate the captured perception data with the captured location data, captured movement data, and navigation map data; determining, from the pre-processed data, lane boundary data, traffic device and sign location data, and lane level intersection data that connects the intersecting and adjoining lanes identified through the lane boundary data; and storing the lane boundary data, traffic device and sign location data, and lane level intersection data in a map file configured for use by an autonomous vehicle.

### BACKGROUND

The present disclosure generally relates to systems and methods for generating maps, and more particularly relates to systems and methods for automatically generating maps suitable for use by autonomous vehicles for navigation.

Navigation level maps, such as OpenStreetMap (OSM) and Google maps, are not suitable for autonomous vehicle (AV) driving. To navigate, an autonomous vehicle may need a high-definition map of the area in which the vehicle will travel. The high-definition map may need to be three-dimensional, annotated with the permanent fixed objects in the area, and include every road in an area to be navigated with the precise location of every stop sign, all the lane markings, every exit ramp and every traffic light.

Creating AV maps can be complex. There are more than four million miles of roads in the United States, and compared with the maps used by GPS and navigation systems, the level of precision for AV maps is much greater. Navigational maps typically locate a vehicle's position within several yards. AV maps, in some cases, may need to be able to locate the position of vehicles, curbs and other objects within about four inches.

Accordingly, it is desirable to provide systems and methods for automatically generating maps suitable for use by autonomous vehicles for navigation. Furthermore, other desirable features and characteristics of the present invention will become apparent from the subsequent detailed description and the appended claims, taken in conjunction with the accompanying drawings and the foregoing technical field and background.

### SUMMARY

Systems and methods for automatically building maps suitable for autonomous driving on public roads are provided. In one embodiment, a processor-implemented method for autonomous vehicle map construction includes automatically capturing location data, movement data, and perception data from a vehicle that has traveled down a road, wherein the location data is captured via a GPS sensor and includes latitude, longitude and heading data, the movement data is captured via one or more of an IMU sensor and an odometry sensor and includes odometry and acceleration data, the perception data is captured via one or more of a camera, lidar and radar and includes lane edge and lane marker detection data that identifies the location of lane edges and lane markers for the road, traffic signage data that identifies the location of traffic signs associated with the road, and traffic signaling device data that identifies the location of traffic signaling devices for the road. The method further includes pre-processing, with a processor, the captured location, movement, and perception data to associate the captured perception data with the captured location data, captured movement data, and navigation map data; determining, with the processor from the pre-processed data, lane boundary data, traffic device and sign location data, and lane level intersection data that connects the intersecting and adjoining lanes identified through the lane boundary data; and storing, on non-transient computer readable media, the lane boundary data, traffic device and sign location data, and lane level intersection data in a map file configured for use by an autonomous vehicle in navigating the road.

In one embodiment, the determining lane boundary data includes: retrieving vehicle trajectory information from the pre-processed data; separating the vehicle trajectory information for a road into a plurality of clusters of vehicle trajectory information for a lane segment; determining lane boundary data for a lane segment from a cluster of vehicle trajectory information for a lane segment using a clustering technique; and connecting lane boundary data for a plurality of lane segments to construct lane boundary data for a lane using trajectory information for lane segments to identify lane segment connection points.

In one embodiment, the determining lane boundary data for a lane segment includes applying a bottom up clustering technique to the cluster of trajectory information for the lane segment, removing outliers from the cluster, and finding a prototype for the cluster wherein the prototype identifies a lane boundary.

In one embodiment, the finding a prototype for the cluster includes updating lane edges by analyzing a batch of data together, the analyzing a batch of data together including removing outliers from the cluster until an outlier threshold is met; computing a weighted average of remaining cluster members; and setting the result of the weighted average computation as the lane prototype.

In one embodiment, the finding a prototype for the cluster includes updating lane edges incrementally, in real time, by applying a Kalman filter to find the prototype for the cluster.

In one embodiment, the determining traffic device and sign location data includes finding traffic devices and signs associated with each lane and intersection and connecting the traffic devices and signs to the associated lanes and intersections.

In one embodiment, the finding traffic devices and signs associated with each lane and intersection includes: removing lower precision device locations from traffic device and sign location data; applying a bottom up clustering technique to the traffic device and sign location data; enforcing minimum span between the traffic device and sign location data; removing outliers from each cluster; and finding a prototype for each cluster, wherein the prototype identifies a traffic device location or traffic sign location.

In one embodiment, the finding a prototype for the cluster includes removing outliers from the cluster until an outlier threshold is met; computing a weighted average of remaining cluster members; and setting result of weighted average computation as lane prototype.

In one embodiment, the finding a prototype for the cluster includes applying a Kalman filter to find the prototype for the cluster.

In one embodiment, the determining lane level intersection data includes: finding the pair of way segments that are connected at an intersection; and filling lane segment connection attributes and intersection incoming lane attributes to identify intersecting lanes in the lane level intersection data.

In another embodiment, an autonomous vehicle map construction module including one or more processors configured by programming instructions in non-transient computer readable media is provided. The autonomous vehicle map construction module is configured to retrieve location data, movement data, and perception data from a vehicle that has traveled down a road, wherein the location data, movement data, and perception data have been automatically captured by the vehicle, the location data was captured via a GPS sensor and includes latitude, longitude and heading data, the movement data was captured via one or more of an IMU sensor and an odometry sensor and includes odometry and acceleration data, the perception data was captured via one or more of a camera, lidar and radar and includes lane edge and lane marker detection data that identifies the location of lane edges and lane markers for the road, traffic signage data that identifies the location of traffic signs associated with the road, and traffic signaling device data that identifies the location of traffic signaling devices for the road. The autonomous vehicle map construction module is further configured to: pre-process the captured location, movement, and perception data to associate the captured perception data with the captured location data, captured movement data, and navigation map data; determine, from the pre-processed data, lane boundary data, traffic device and sign location data, and lane level intersection data that connects the intersecting and adjoining lanes identified through the lane boundary data; and store, on non-transient computer readable media, the lane boundary data, traffic device and sign location data, and lane level intersection data in a map file configured for use by an autonomous vehicle in navigating the road.

In one embodiment, to determine lane boundary data, the module is configured to: retrieve vehicle trajectory information from the pre-processed data; separate the vehicle trajectory information for a road into a plurality of clusters of vehicle trajectory information for a lane segment; determine lane boundary data for a lane segment from a cluster of vehicle trajectory information for a lane segment using a clustering technique; and connect lane boundary data for a plurality of lane segments to construct lane boundary data for a lane using trajectory information for lane segments to identify lane segment connection points.

In one embodiment, to determine lane boundary data for a lane segment, the module is configured to apply a bottom up clustering technique to the cluster of trajectory information for the lane segment, remove outliers from the cluster, and find a prototype for the cluster wherein the prototype identifies a lane boundary.

In one embodiment, to find a prototype for the cluster, the module is configured to update lane edges by analyzing a batch of data together, to analyze a batch of data together the module is configured to remove outliers from the cluster until an outlier threshold is met; compute a weighted average of the remaining cluster members; and set the result of the weighted average computation as the lane prototype.

In one embodiment, to find a prototype for the cluster, the module is configured to update lane edges incrementally, in real time, by applying a Kalman filter to find the prototype for the cluster.

In one embodiment, to determine traffic device and sign location data, the module is configured to find traffic devices and signs associated with each lane and intersection and connect the traffic devices and signs to the associated lanes and intersections.

In one embodiment, to find traffic devices and signs associated with each lane and intersection, the module is configured to: remove lower precision device locations from traffic device and sign location data; apply a bottom up clustering technique to the traffic device and sign location data; enforce minimum span between the traffic device and sign location data; remove outliers from each cluster; and find a prototype for each cluster, wherein the prototype identifies a traffic device location or traffic sign location.

In one embodiment, to find a prototype for the cluster, the module is configured to remove outliers from the cluster until an outlier threshold is met; compute a weighted average of remaining cluster members; and set the result of weighted average computation as the lane prototype.

In one embodiment, to determine lane level intersection data, the module is configured to: find a pair of way segments that are connected at an intersection; and fill lane segment connection attributes and intersection incoming lane attributes to identify intersecting lanes in the lane level intersection data.

In another embodiment, an autonomous vehicle includes a controller configured by programming instructions on non-transient computer readable media to control the navigation of the autonomous vehicle using an autonomous vehicle map file stored onboard the autonomous vehicle. The autonomous vehicle map file was constructed by an autonomous vehicle map construction module configured to: retrieve location data, movement data, and perception data from a vehicle that has traveled down a road, wherein the location data, movement data, and perception data were automatically captured in the vehicle, the location data was captured via a GPS sensor and includes latitude, longitude and heading data, the movement data was captured via one or more of an IMU sensor and an odometry sensor and includes odometry and acceleration data, the perception data was captured via one or more of a camera, lidar and radar and includes lane edge and lane marker detection data that identifies the location of lane edges and lane markers for the road, traffic signage data that identifies the location of traffic signs associated with the road, and traffic signaling device data that identifies the location of traffic signaling devices for the road. The autonomous vehicle map construction module is further configured to: pre-process the captured location, movement, and perception data to associate the captured perception data with the captured location data, captured movement data, and navigation map data; determine, from the pre-processed data, lane boundary data, traffic device and sign location data, and lane level intersection data that connects the intersecting and adjoining lanes identified through the lane boundary data; and store, on non-transient computer readable media, the lane boundary data, traffic device and sign location data, and lane level intersection data in a map file configured for use by an autonomous vehicle in navigating the road.

### DESCRIPTION OF THE DRAWINGS

The exemplary embodiments will hereinafter be described in conjunction with the following drawing figures, wherein like numerals denote like elements, and wherein:

FIG. 1 is a block diagram depicting an autonomous vehicle mapping system, in accordance with various embodiments;

FIG. 2 is a block diagram of an example vehicle that employs a map data collection module, in accordance with various embodiments;

FIG. 3 is a block diagram depicting example sub-modules and operations performed in an example map generation module, in accordance with various embodiments;

FIG. 4 is a block diagram depicting example operations performed in an example map generation module when performing operations relating to lane finding and sorting, in accordance with various embodiments;

FIG. 5A is a process flow chart depicting example operations performed in an example map generation module to remove outliers from each cluster and find a prototype for each cluster, in accordance with various embodiments;

FIG. 5B is a process flow chart depicting example operations in an example process performed in an example map generation module to remove outliers from each cluster and for finding a prototype for each cluster, in accordance with various embodiments;

FIG. 6 is a block diagram depicting example operations performed in an example map generation module when performing operations relating to generating traffic device and traffic sign location data to include in an AV map file, in accordance with various embodiments;

FIG. 7 is a block diagram depicting example operations performed in an example map generation module when performing operations relating to connecting the intersecting and adjoining lanes identified through the lane boundary data, in accordance with various embodiments; and

FIG. 8 is process flow chart depicting an example process for autonomous vehicle map construction, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Described herein are apparatus, systems, methods, techniques and articles for generating AV drivable maps. The described apparatus, systems, methods, techniques and articles can generate AV drivable maps that are readily updatable and tailorable and that use commonly available sensors.

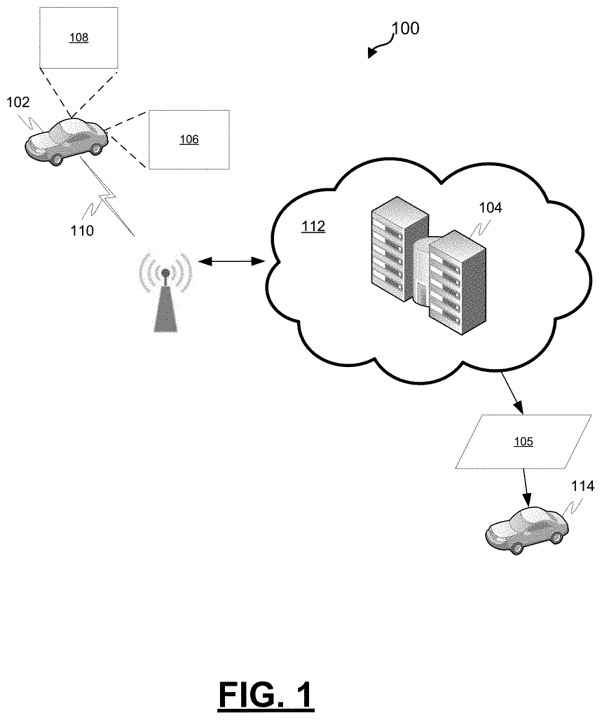

FIG. 1 is a block diagram depicting an autonomous vehicle mapping system 100. The example system 100 is configured to create a detailed map that is suitable for use with autonomous vehicle navigation. The example autonomous vehicle mapping system 100 includes one or more vehicles 102 that traverse roads in an area to be mapped and a map generation module 104, implemented by a cloud-based server, that is configured to generate a map 105 that is sufficiently detailed for use by an autonomous vehicle in navigating. The map generation module 104 is configured to use navigation map data (e.g., OSM) that includes data regarding roads and intersections and data captured by vehicles 102 to generate the autonomous vehicle (AV) map 105.

Each vehicle 102 includes one or more onboard sensors 106 and a map data collection module 108. The sensors 106 may include camera, lidar, radar, GPS, odometry, and other sensors. The map data collection module 108 is configured to collect certain data captured by the onboard sensors while the vehicle 102 traverses through a path on roads to be mapped and transmit the collected data to the map generation module 104. The captured data may include perception data that identify lane edges, curbs, traffic devices, traffic signs, and other items of which an autonomous vehicle may need to be aware when navigating. The perception data may be captured via camera sensors, lidar sensors, radar sensors, and others onboard the vehicle 102. The captured data may also include location and movement data for the vehicle 102 as it traverses the roads and captures perception data. The location and movement data may include the vehicle latitude, longitude, heading, odometry data, and acceleration data, among others. The map data collection module 108 is configured to communicate with the map generation module 104, for example, via a cellular communication channel 110 over a cellular network such as 4G LTE or 4G LTE-V2X, a public network, and a private network 112.

The example map generation module 104 is configured to receive and analyze data captured by the onboard sensors 106 on the vehicle(s) 102 and transmitted to the map generation module 104 via the map data collection module 108. The example map generation module 104 is further configured to, in connection with mapping data from a non-detailed navigational map, construct the detailed autonomous vehicle map 105 for use by an autonomous vehicle 114 in navigating.

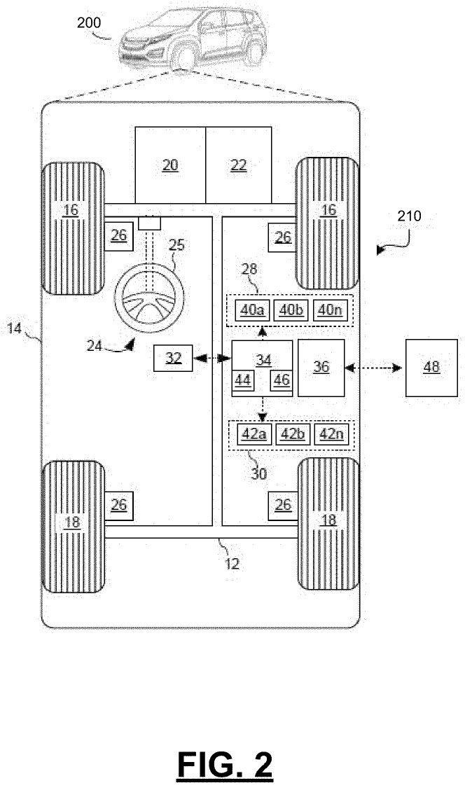

FIG. 2 is a block diagram of an example vehicle 200 that employs a map data collection module 108 and possesses onboard sensors 106. The example vehicle 200 generally includes a chassis 12, a body 14, front wheels 16, and rear wheels 18. The body 14 is arranged on the chassis 12 and substantially encloses components of the vehicle 200. The body 14 and the chassis 12 may jointly form a frame. The wheels 16-18 are each rotationally coupled to the chassis 12 near a respective corner of the body 14.

The example vehicle 200 may be an autonomous vehicle (e.g., a vehicle that is automatically controlled to carry passengers from one location to another), a semi-autonomous vehicle or a passenger-driven vehicle. In any case, a map data collection module 210 is incorporated into the example vehicle 200. The example vehicle 200 is depicted as a passenger car but may also be another vehicle type such as a motorcycle, truck, sport utility vehicle (SUV), recreational vehicles (RV), marine vessel, aircraft, etc.

The example vehicle 200 includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios.

The sensor system 28 includes one or more sensing devices 40a-40n that sense observable conditions of the exterior environment and/or the interior environment of the vehicle 200 (such as the state of one or more occupants) and generate sensor data relating thereto. Sensing devices 40a-40n might include, but are not limited to, radars (e.g., long-range, medium-range-short range), lidars, global positioning systems (GPS), optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, vehicle 200 may also include interior and/or exterior vehicle features not illustrated in FIG. 2, such as various doors, a trunk, and cabin features such as air, music, lighting, touch-screen display components (such as those used in connection with navigation systems), and the like.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 200. In various embodiments, controller 34 is configured to implement a map data collection module 210 as discussed in detail below.

The controller 34 may implement a map data collection module 210. That is, suitable software and/or hardware components of controller 34 (e.g., processor 44 and computer-readable storage device 46) are utilized to provide a map data collection module 210 that is used in conjunction with vehicle 200.

The instructions may include one or more separate programs, each of which comprises an ordered listing of executable instructions for implementing logical functions. The instructions, when executed by the processor 44, receive and process signals (e.g., sensor data) from the sensor system 28, perform logic, calculations, methods and/or algorithms for controlling the components of the vehicle 200, and generate control signals that are transmitted to the actuator system 30 to automatically control the components of the vehicle 200 based on the logic, calculations, methods, and/or algorithms. Although only one controller 34 is shown in FIG. 2, embodiments of the vehicle 200 may include any number of controllers 34 that communicate over a suitable communication medium or a combination of communication mediums and that cooperate to process the sensor signals, perform logic, calculations, methods, and/or algorithms, and generate control signals to automatically control features of the vehicle 200.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

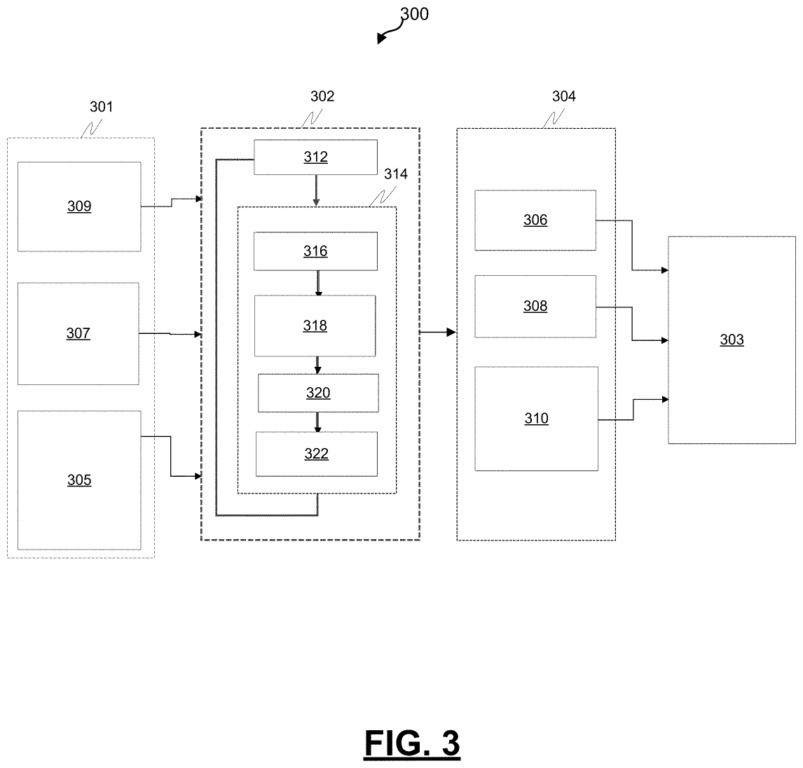

FIG. 3 is a block diagram depicting example sub-modules and operations performed in an example map generation module 300. The example map generation module 300 includes a data pre-processing module 302 and a map data generation module 304. The example pre-processing module 302 is configured to format input data 301 in a manner that can be used by the sub-modules in the map data generation module 304 to generate a detailed AV map file 303 for use by autonomous vehicles in navigating.

The example data pre-processing module 302 is configured to retrieve input data 301 for the example map generation module 300. The example input data 301 includes automatically captured location and movement data 305 and perception data 307 from one or more vehicle(s) that have traveled down one or more roads to be included in the AV map file 303. The example location data 305 was automatically captured by the vehicle(s) via an onboard GPS sensor and includes latitude, longitude, and heading data. The example movement data 305 was automatically captured by the vehicle(s) via one or more of an onboard IMU sensor and an onboard odometry sensor and includes odometry and acceleration data. The example perception data 307 was automatically captured by the vehicle(s) via one or more of a camera, lidar, and radar and includes lane edge and lane marker detection data that identifies the location of lane edges and lane markers for the road, traffic signage data that identifies the location of traffic signs associated with the road, and traffic signaling device data that identifies the location of traffic signaling devices for the road. The input data 301 may have been collected by a map data collection module 108/210 and transmitted to the map generation module 300 via the map data collection module 108/210. The example input data 301 may also includes lower precision navigation map data 309, for example, from a navigational map such as one offered by OpenStreetMap (OSM).

The example data pre-processing module 302 is further configured to pre-process the input data 301 to associate the captured perception data 307 with the captured location and movement data 305 and navigation map data 309. The pre-processing may include aggregating multiple files (operation 312), each of which containing a vehicle's trajectory down one or more roads, and pre-processing each file (operation 314). Pre-processing a file may include parsing the data in the file (operation 316), associating trajectories in the data to travel ways (operation 318), serializing associated data (operation 320), and visualizing associated data (operation 322).

The example map data generation module 304 is configured to determine, from the pre-processed data, lane location information, traffic device location information, and lane level intersection information. The example map data generation module 304 includes a lane finding and sorting module 306 that is configured to generate lane boundary data from the input data, a traffic device and sign find and placement module 308 that is configured to generate traffic device location data and traffic sign location data, and a lane level intersection finding and connection module 310 that is configured to connect the intersecting and adjoining lanes identified through the lane boundary data.

The example map data generation module 304, through its sub-modules—the lane finding and sorting module 306, the traffic device and sign find and placement module 308, and the lane level intersection finding and connection module 310—is configured to generate an AV map file 303, that is detailed enough to be used by an autonomous vehicle for navigation. The AV map file 303 may include detailed lane location data, detailed intersection location data, detailed traffic device location data, detailed traffic sign location data, detailed lane connection data, detailed lane speed limit data, and detailed device lane associations. The example map data generation module 304 is further configured to store the detailed information in the AV map file 303.

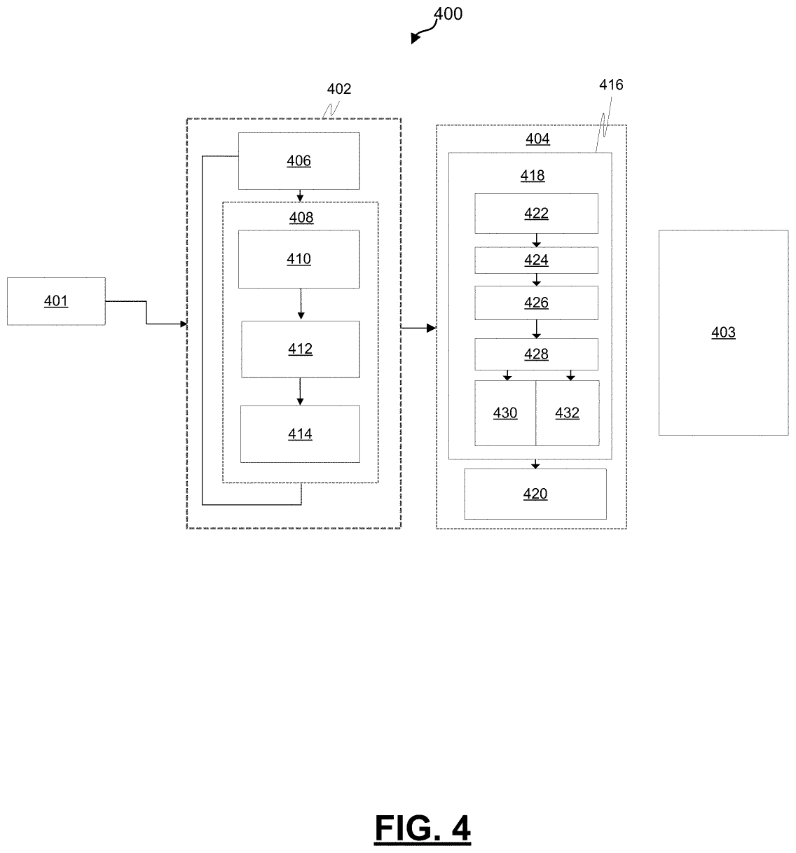

FIG. 4 is a block diagram depicting example operations performed in an example map generation module 400 when performing operations relating to lane finding and sorting. The example map generation module 400 includes a data pre-processing module 402 and a map data generation module 404. The example pre-processing module 402 is configured to format input data 401 in a manner that can be used by the map data generation module 404 to generate a detailed AV map file 403 for use by autonomous vehicles in navigating.

The example data pre-processing module 402 is configured to retrieve input data 401 for the example map generation module 400. The example input data 401 includes automatically captured location data, movement data, and perception data from one or more vehicle(s) that have traveled down one or more roads to be included in the AV map file 403. The input data 401 may have been collected by a map data collection module 108/210 and transmitted to the map generation module 400 via the map data collection module 108/210. The example input data 401 may also include lower precision navigation map data.

The example data pre-processing module 402 is further configured to pre-process the input data 401 to associate the captured perception data with captured location, movement, and navigation map data. The pre-processing may include aggregating multiple files (operation 406), each of which containing a vehicle's trajectory down one or more roads, and pre-processing each file (operation 408). Pre-processing a file may include associating trajectories in the data to road segments (operation 410), extracting and associating edge markers to road segments (operation 412), and aggregating connection trajectory points (operation 414).

The example map data generation module 404 is configured to determine, from the pre-processed data, lane location information. The example map data generation module 404 includes a lane finding and sorting module 416 that is configured to generate lane boundary data from the input data 401.

The example map data generation module 404, through the lane finding and sorting module 416, is configured to generate lane location information for an AV map file 403, that is detailed enough to be used by an autonomous vehicle for navigation. The AV map file 403 may include detailed lane location data, detailed intersection location data, detailed traffic device location data, detailed traffic sign location data, detailed lane connection data, detailed lane speed limit data, and detailed device lane associations. The example map data generation module 404 is further configured to store the detailed information in the AV map file 403.

The example lane finding and sorting module 416 is configured to determine, from the preprocessed data, lane location information. The example lane finding and sorting module 416 is configured to determine the lane location information by: separating the vehicle trajectory information for a road into a plurality of clusters of vehicle trajectory information for a lane segment (operation 418); and connecting lane boundary data for a plurality of lane segments to construct lane boundary data for a lane using trajectory information for lane segments to identify lane segment connection points (operation 420). The example lane finding and sorting module 416 is configured to separate the vehicle trajectory information by applying a clustering technique to the lane segment trajectory information to determine lane segment boundaries for a lane segment. The example clustering technique includes: pushing trajectory location uncertainty to the most prominent lane edge (operation 422); applying a bottom up clustering technique to the lane trajectory information to determine lane edge position information (operation 424); applying a multi-intra-trajectory-distance measure to the lane edge position information (operation 426); enforcing maximum span between lanes (operation 428); removing outliers from each cluster (operation 430); and finding a prototype for each cluster (operation 432), wherein the prototype identifies a lane boundary.

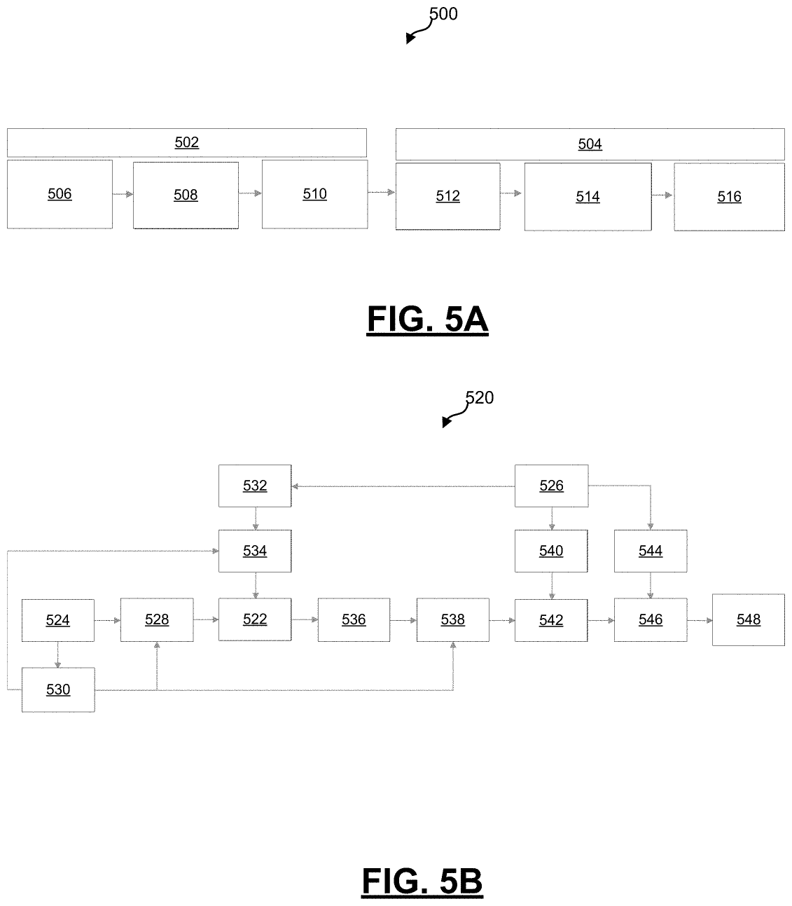

FIG. 5A is a process flow chart depicting example operations in an example process 500 performed in an example map generation module 400 to update lane edges in batch mode, or as a batch of data analyzed together, and not incrementally. The example process 500 include operations to remove outliers from each cluster (operation 502) and find a prototype for each cluster (operation 504). The example operations for removing outliers from each cluster include: within a lane cluster, determining the most distant pair of trajectories (operation 506); applying a weighted combination of closeness measures to all pairs of trajectories (operation 508); and eliminating the most distant pair of trajectories (operation 510). The example operations for finding a prototype for each cluster include: repeating the operations for removing outliers from each cluster until an outlier threshold is met (operation 512); computing a weighted average (along track) of remaining cluster members (operation 514); and setting result of weighted average computation as lane prototype (operation 516).

FIG. 5B is a process flow chart depicting example operations in an example process 520 performed in an example map generation module 400 to update lane edges incrementally, in real time. The example process 500 include operations to remove outliers from each cluster and for finding a prototype for each cluster. The example process 520 includes removing outliers from each cluster and finding a prototype for each cluster by fusing data and prior knowledge using a Kalman filter 522. The Kalman filter 522 can smooth an output that converges to a nominal lane width and center when data is missing. The example process 520 includes use of the Kalman filter 522, data from lane sensor(s) 524, and data from GPS sensor 526.

In the example process 520, data from lane sensors (524) are used to compute lane distances in the lane frame (operation 528). Data from lane sensors (524) are also used to compute the host vehicle heading in the lane frame (operation 530). The computed lane distances are inputted to a robust Kalman filter (522). At the same time, data from a GPS sensor (526) is used to determine a host vehicle speed in a global frame (operation 532). The host vehicle's longitudinal speed is calculated (operation 532) using the host vehicle speed in the global frame (532) and the host vehicle heading in the lane frame (530). The computed longitudinal speed (534) is also inputted to the robust Kalman filter (522). The robust Kalman filter (522) outputs fused lane center and widths position information (536). The fused lane center and widths position information (536) is converted to the host vehicle frame (operation 538). The host vehicle heading in the global frame (540) is derived from the GPS sensor (526). The host vehicle heading in the global frame (540) is used to convert the fused lane center and widths position in the host vehicle frame (538) to the global frame (operation 542). The host vehicle position in the global frame (544) is summed (operation 546) with the fused lane center and widths position in the global frame (542) to yield a lane edge coordinate in the global frame (548).

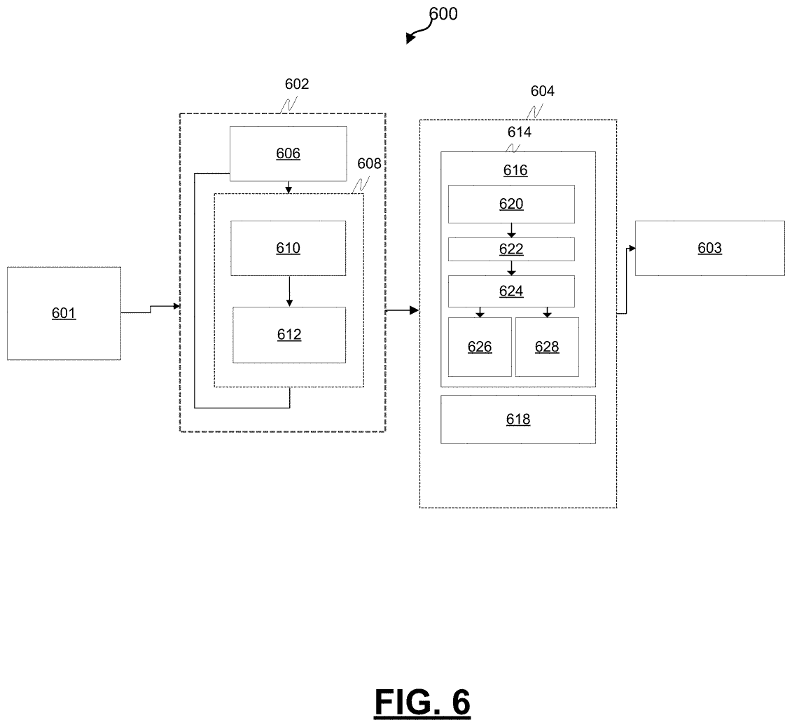

FIG. 6 is a block diagram depicting example operations performed in an example map generation module 600 when performing operations relating to generating traffic device and traffic sign location data to include in an AV map file. The example map generation module 600 includes a data pre-processing module 602 and a map data generation module 604. The example pre-processing module 602 is configured to format input data 601 in a manner that can be used by the map data generation module 604 to generate a detailed AV map file 603 for use by autonomous vehicles in navigating.

The example data pre-processing module 602 is configured to retrieve input data 601 for the example map generation module 600. The example input data 601 includes automatically captured location data, movement data, and perception data from one or more vehicle(s) that have traveled down one or more roads to be included in the AV map file 603. The input data 601 may have been collected by a map data collection module 108/210 and transmitted to the map generation module 600 via the map data collection module 108/210. The example input data 601 may also include lower precision navigation map data.

The example data pre-processing module 602 is further configured to pre-process the input data 601 to associate the captured perception data with captured location, movement, and navigation map data. The pre-processing may include aggregating multiple files (operation 606), each of which containing a vehicle's trajectory down one or more roads, and pre-processing each file (operation 608). Pre-processing a file may include associating trajectories in the data to road segments (operation 610) and associating trajectories in the data to intersections (operation 612).

The example map data generation module 604 is configured to determine, from the preprocessed data, traffic device location and traffic sign location information. The example map data generation module 604 includes a traffic device and sign find and placement module 614 that is configured to generate traffic device location and traffic sign location information from the input data 601.

The example map data generation module 604, through the traffic device and sign find and placement module 614, is configured to generate traffic device location and traffic sign location information by finding a subset of representative devices for each lane/intersection (operation 616) and connecting devices to lanes and intersections (operation 618). The finding subset of representative devices for each lane/intersection involves using a clustering technique. The clustering technique includes: remove lower precision device locations (operation 620); applying a bottom up clustering technique to the device location and traffic sign location information (operation 622); enforcing minimum span between traffic device location and traffic sign location information (operation 624); removing outliers from each cluster (operation 626); and finding the prototype for each cluster (operation 628), wherein the prototype identifies a traffic device location or traffic sign location.

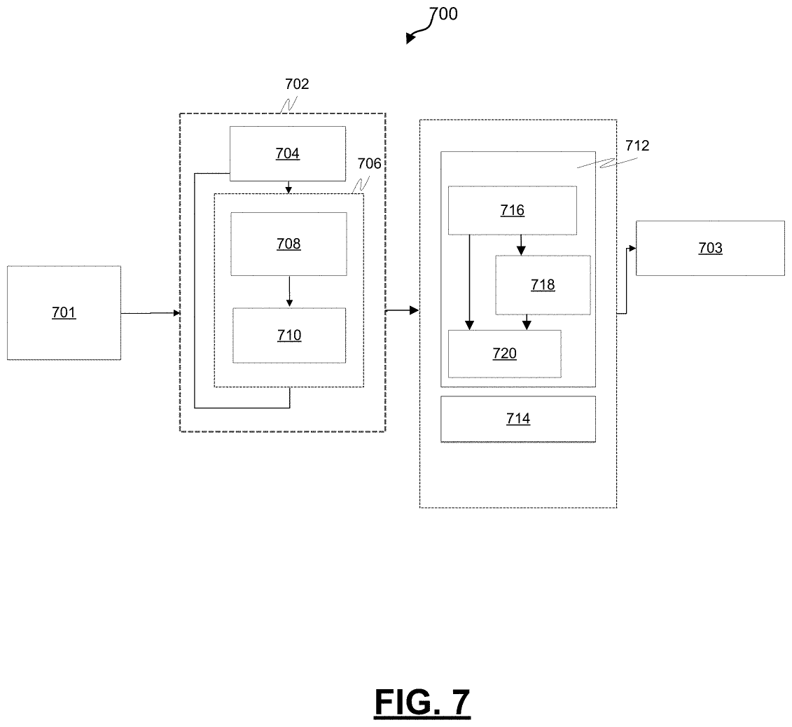

FIG. 7 is a block diagram depicting example operations performed in an example map generation module 700 when performing operations relating to connecting the intersecting and adjoining lanes identified through the lane boundary data. The example map generation module 700 includes a map data generation module 702. The example map data generation module 702 is configured to retrieve lane location information data 701 that was generated in connection with a lane finding and sorting module (e.g., lane finding and sorting module 416).

The example map data generation module 702 is further configured to connect the intersecting and adjoining lanes identified through the lane boundary data by identifying lane segments and intersections (operation 704) and create connections (operation 706). The example map data generation module 702 is configured to create connections by finding lane segments that are from a similar source (operation 708) and create a connection (operation 710).

In one example implementation, these operations involve finding the pair of way segments (OSM) that are connected at an intersection (operation 712); and filling the lane segment connection attributes and intersection incoming lane attributes (operation 714). The finding the pair of way segments (OSM) that are connected at an intersection may be performed by: attempting to select the lane segments that are from the same source (driven log) in the way segment pair (operation 716). If lane segments from the same source in the way segment pair are not found, then find the eliminated sources in the clustering process and check for source match (operation 718). If lane segments from the same source in the way segment pair are found, then connect them either from driven points or by creating a new connection (operation 720). Performance of these operations can result in connected lanes at intersection data 703 for inclusion in an AV map file.

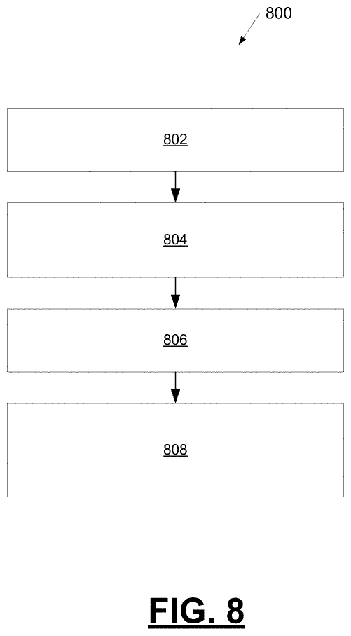

FIG. 8 is process flow chart depicting an example process 800 for autonomous vehicle map construction. The order of operation within the example process 800 is not limited to the sequential execution as illustrated in the figure, but may be performed in one or more varying orders as applicable and in accordance with the present disclosure.

The example process 800 includes automatically capturing location data, movement data, and sensor data from a vehicle that has traveled down a road (operation 802). The location data may be captured via a GPS sensor and include latitude, longitude, and heading data. The movement data may be captured via one or more of an IMU sensor and an odometry sensor and include odometry and acceleration data. The sensor data may be captured via one or more of a camera, lidar, and radar and include lane edge and lane marker detection data for the road, traffic signage data for the road, and traffic signaling device data for the road.

The example process 800 also includes preprocessing the captured location, movement, and sensor data to associate the captured sensor data with the captured location data, captured movement data, and navigation map data (operation 804). The pre-processing may be performed in a manner consistent with the operations the example data pre-processing module 402 and the example data pre-processing module 602 are configured to perform.

The example process 800 further includes determining, from the preprocessed data, lane location information, traffic device location information, and lane level intersection data (operation 806). The determining may be performed in a manner consistent with the operations the example map data generation module 404, example map data generation module 604, and example map data generation module 702 are configured to perform.

Finally, the example process 800 includes storing the lane information, traffic device location information, and lane level intersection data in a map file configured for use by an autonomous vehicle in navigating the road (operation 808).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A processor-implemented method for autonomous vehicle map construction, the method comprising:
automatically capturing location data, movement data, and perception data from a vehicle that has traveled down a road, the location data captured via a GPS sensor and including latitude, longitude and heading data, the movement data captured via one or more of an IMU sensor and an odometry sensor and including odometry and acceleration data, the perception data captured via one or more of a camera, lidar and radar and including lane edge and lane marker detection data that identifies the location of lane edges and lane markers for the road, traffic signage data that identifies the location of traffic signs associated with the road, and traffic signaling device data that identifies the location of traffic signaling devices for the road;
pre-processing, with a processor, the captured location, movement, and perception data to associate the captured perception data with the captured location data, captured movement data, and navigation map data;
determining, with the processor from the pre-processed data, lane boundary data, traffic device and sign location data, and lane level intersection data that connects the intersecting and adjoining lanes identified through the lane boundary data; and
storing, on non-transient computer readable media, the lane boundary data, traffic device and sign location data, and lane level intersection data in a map file configured for use by an autonomous vehicle in navigating the road.

2. The method of claim 1, wherein the determining lane boundary data comprises:
retrieving vehicle trajectory information from the pre-processed data;
separating the vehicle trajectory information for a road into a plurality of clusters of vehicle trajectory information for a lane segment;
determining lane boundary data for a lane segment from a cluster of vehicle trajectory information for a lane segment using a clustering technique; and
connecting lane boundary data for a plurality of lane segments to construct lane boundary data for a lane using trajectory information for lane segments to identify lane segment connection points.

3. The method of claim 2, wherein the determining lane boundary data for a lane segment comprises applying a bottom up clustering technique to the cluster of trajectory information for the lane segment, removing outliers from the cluster, and finding a prototype for the cluster wherein the prototype identifies a lane boundary.

4. The method of claim 3, wherein the finding a prototype for the cluster comprises updating lane edges by analyzing a batch of data together, the analyzing a batch of data together comprising removing outliers from the cluster until an outlier threshold is met;
computing a weighted average of remaining cluster members; and setting the result of the weighted average computation as the lane prototype.

5. The method of claim 3, wherein the finding a prototype for the cluster comprises updating lane edges incrementally, in real time, by applying a Kalman filter to find the prototype for the cluster.

6. The method of claim 1, wherein the determining traffic device and sign location data comprises finding traffic devices and signs associated with each lane and intersection and connecting the traffic devices and signs to the associated lanes and intersections.

7. The method of claim 6, wherein the finding traffic devices and signs associated with each lane and intersection comprises:
removing lower precision device locations from traffic device and sign location data;
applying a bottom up clustering technique to the traffic device and sign location data;
enforcing minimum span between the traffic device and sign location data;
removing outliers from each cluster; and
finding a prototype for each cluster, wherein the prototype identifies a traffic device location or traffic sign location.

8. The method of claim 7, wherein the finding a prototype for the cluster comprises removing outliers from the cluster until an outlier threshold is met; computing a weighted average of remaining cluster members; and setting result of weighted average computation as lane prototype.

9. The method of claim 7, wherein the finding a prototype for the cluster comprises applying a Kalman filter to find the prototype for the cluster.

10. The method of claim 1, wherein the determining lane level intersection data comprises:
finding the pair of way segments that are connected at an intersection; and
filling lane segment connection attributes and intersection incoming lane attributes to identify intersecting lanes in the lane level intersection data.

11. An autonomous vehicle map construction module, the autonomous vehicle map construction module comprising one or more processors configured by programming instructions in non-transient computer readable media, the autonomous vehicle map construction module configured to:
retrieve location data, movement data, and perception data from a vehicle that has traveled down a road, the location data, movement data, and perception data having been automatically captured in the vehicle, the location data captured via a GPS sensor and including latitude, longitude and heading data, the movement data captured via one or more of an IMU sensor and an odometry sensor and including odometry and acceleration data, the perception data captured via one or more of a camera, lidar and radar and including lane edge and lane marker detection data that identifies the location of lane edges and lane markers for the road, traffic signage data that identifies the location of traffic signs associated with the road, and traffic signaling device data that identifies the location of traffic signaling devices for the road;
pre-process the captured location, movement, and perception data to associate the captured perception data with the captured location data, captured movement data, and navigation map data;
determine, from the pre-processed data, lane boundary data, traffic device and sign location data, and lane level intersection data that connects the intersecting and adjoining lanes identified through the lane boundary data; and
store, on non-transient computer readable media, the lane boundary data, traffic device and sign location data, and lane level intersection data in a map file configured for use by an autonomous vehicle in navigating the road.

12. The autonomous vehicle map construction module of claim 11, wherein to determine lane boundary data, the module is configured to:
retrieve vehicle trajectory information from the pre-processed data;
separate the vehicle trajectory information for a road into a plurality of clusters of vehicle trajectory information for a lane segment;
determine lane boundary data for a lane segment from a cluster of vehicle trajectory information for a lane segment using a clustering technique; and
connect lane boundary data for a plurality of lane segments to construct lane boundary data for a lane using trajectory information for lane segments to identify lane segment connection points.

13. The autonomous vehicle map construction module of claim 12, wherein to determine lane boundary data for a lane segment, the module is configured to apply a bottom up clustering technique to the cluster of trajectory information for the lane segment, remove outliers from the cluster, and find a prototype for the cluster wherein the prototype identifies a lane boundary.

14. The autonomous vehicle map construction module of claim 13, wherein to find a prototype for the cluster, the module is configured to update lane edges by analyzing a batch of data together, to analyze a batch of data together the module is configured to remove outliers from the cluster until an outlier threshold is met; compute a weighted average of the remaining cluster members; and set the result of the weighted average computation as the lane prototype.

15. The autonomous vehicle map construction module of claim 13, wherein to find a prototype for the cluster, the module is configured to update lane edges incrementally, in real time, by applying a Kalman filter to find the prototype for the cluster.

16. The autonomous vehicle map construction module of claim 11, wherein to determine traffic device and sign location data, the module is configured to find traffic devices and signs associated with each lane and intersection and connect the traffic devices and signs to the associated lanes and intersections.

17. The autonomous vehicle map construction module of claim 16, wherein to find traffic devices and signs associated with each lane and intersection, the module is configured to:
remove lower precision device locations from traffic device and sign location data;
apply a bottom up clustering technique to the traffic device and sign location data;
enforce minimum span between the traffic device and sign location data;
remove outliers from each cluster; and
find a prototype for each cluster, wherein the prototype identifies a traffic device location or traffic sign location.

18. The autonomous vehicle map construction module of claim 17, wherein to find a prototype for the cluster, the module is configured to remove outliers from the cluster until an outlier threshold is met; compute a weighted average of remaining cluster members; and set the result of weighted average computation as the lane prototype.

19. The autonomous vehicle map construction module of claim 11, wherein to determine lane level intersection data, the module is configured to:
find a pair of way segments that are connected at an intersection; and
fill lane segment connection attributes and intersection incoming lane attributes to identify intersecting lanes in the lane level intersection data.

20. An autonomous vehicle comprising a controller configured by programming instructions on non-transient computer readable media to control the navigation of the autonomous vehicle using an autonomous vehicle map file stored onboard the autonomous vehicle, the autonomous vehicle map file constructed by an autonomous vehicle map construction module configured to:
retrieve location data, movement data, and perception data from a vehicle that has traveled down a road, the location data, movement data, and perception data having been automatically captured in the vehicle, the location data captured via a GPS sensor and including latitude, longitude and heading data, the movement data captured via one or more of an IMU sensor and an odometry sensor and including odometry and acceleration data, the perception data captured via one or more of a camera, lidar and radar and including lane edge and lane marker detection data that identifies the location of lane edges and lane markers for the road, traffic signage data that identifies the location of traffic signs associated with the road, and traffic signaling device data that identifies the location of traffic signaling devices for the road;
pre-process the captured location, movement, and perception data to associate the captured perception data with the captured location data, captured movement data, and navigation map data;
determine, from the pre-processed data, lane boundary data, traffic device and sign location data, and lane level intersection data that connects the intersecting and adjoining lanes identified through the lane boundary data; and
store, on non-transient computer readable media, the lane boundary data, traffic device and sign location data, and lane level intersection data in a map file configured for use by an autonomous vehicle in navigating the road.
